(19) United States
(12) Patent Application Publication
(10) Pub. No.: US 2006/0283363 A1
(43) Pub. Date: Dec. 21, 2006

(54) Potato Planter Improvement to Reduce Skips and Rolling

(76) Inventors: Albert E. Wollman, Warden, WA (US); Michael J. Wollman, Warden, WA (US)

Correspondence Address: VANTAGE LAW PLLC, 355 NW GILMAN BLVD., SUITE 203, ISSAQUAH, WA, 98027, US

(21) Appl. No.: 11/422,876

(22) Filed: Jun. 7, 2006

Related U.S. Application Data
(60) Provisional application No. 60/687,898, filed on Jun. 7, 2005.
(60) Provisional application No. 60/759,078, filed on Jan. 17, 2006.

(51) Int. Cl. A01C 7/18

(52) U.S. Cl. 111/15

(57) ABSTRACT

An improved cup-style potato planter that corrects seed “skips.” Cups on a continuous belt conveyor sometimes fail to pick up potato seeds from a bin, or the seeds drop from the cup due to vibration. The design disclosed here puts replacement seeds in empty cups before the conveyor reaches a point in conveyor travel where the seed is supposed to be dropped into the ground.

### RELATED APPLICATIONS AND INFORMATION INCORPORATED BY REFERENCE

This specification claims priority on provisional Application Ser. No. 60/687,898, filed on Jun. 07, 2005, and provisional Application Ser. No. 60/759,078, filed on Jan. 17, 2006.

### TECHNICAL FIELD

The invention disclosed here relates to a potato seed planter that improves upon seed planting and seed skips, in particular, when potato seeds are mechanically planted in a field row.

### BACKGROUND OF THE INVENTION

Commercial potato growers favor two or three types of potato seed planting machines. One type is a “pick” style machine that has a spiked wheel that rotates as a tractor pulls the machine over the ground. The spikes on the wheel “stick” into, and pick up, individual potato seeds from a bin. The seeds are dropped in a furrow as the wheel rotates.

A second type of machine is called a “cup” style machine by farmers. The second machine has an upright, endless or continuous conveyor belt that carries cups up through a seed bin on one side of the belt, picking up seeds along the way, and then dropping the seeds in the ground at the end of belt travel on the downward side.

There is a third type of machine that operates in similar fashion to the “pick” type machine, except that the mechanical picks are replaced by vacuum tube. Each tube attaches to an individual potato seed in the seed bin by suction, as the wheel rotates, and then drops the seed in the ground at the appropriate time.

Potato seeds are either small potatoes or cut sections of larger potatoes, leaving “eyes” for sprouting plants. Cut seeds will be partly squared off where they are cut and partly natural where the potato eyes and skin remain.

Of the three traditional machines described above, the vacuum tube machine probably does the most accurate planting job in the field because it tends to generate fewer planting skips. However, it also has a complex system of individual vacuum tubes, each one of which needs to be connected to a vacuum source. This higher level of mechanical complexity makes the machine more expensive to use. Machine maintenance, in particular, is more expensive for this machine relative to others.

Seed planting machines are built according to the number of “rows”—with varying numbers of wheel or conveyor units being mounted to a frame as stand-alone but commonly driven modules that plant the desired number of rows at the same time (e.g., one, two, four, or eight row planters, etc.). These machines are used to plant large acreages in the potato growing regions of the United States, and elsewhere.

Because of market-driven forces that have increased the demand for uniformity in size and shape of harvested potatoes, seed planting machines are designed with the goal of depositing potato seeds with uniform spacing in the furrow, so that plants will have optimum spacing as they mature. This reduces shape deformities caused by plant over-crowding when the seeds are planted too close together.

Potato processors who purchase potato crops from the growers may discount prices depending on the number of off-size or off-shape potatoes that the grower delivers. Therefore, it is important to the grower that planted seeds are placed in the ground with uniform spacing.

At the same time, it is important that a single seed be placed in every space that is allocated for a plant in a field row. If a seed is not planted where a seed could or should be planted, then the potato grower loses a unit of production.

A known problem with seed planting machines is that they do not achieve 100% perfection in seed planting. Because the planting machine either fails to “stick” to a potato seed well enough (e.g., the “pick” or “vacuum” type machines), or a conveyor cup fails to pick up a potato from the bin in the other kind of machine, potato rows are planted with seed “skips” in the row. Planting skips create blank or barren spots in the field where plants should have been planted.

The Warden Hutterite Brotherhood (“WHB”) plants approximately 5000 acres of potatoes every year. While the precise number of planting skips is not known, it is estimated that some machines may plant with 10% skips. For a large grower like WHB, skips of this magnitude effectively create a situation where 500 acres of land went unplanted—which is a significant loss in production. At the same time, all of the costs for that unplanted acreage are still incurred, because things like irrigation, spraying and harvesting equipment cover all of the ground, in the same way, without distinguishing between planted and unplanted spots. Losses due to skipping, therefore, directly affect the bottom line in terms of profit. Even a 1 or 2% reduction in seed skipping will create very significant revenue increases for growers with large acreages—without a corresponding cost increase.

As just indicated, a machine having the capability of planting potato seeds with fewer skips in the row represents a valuable improvement. However, any improvement in potato seed planting tends to create a revenue increase, either directly or indirectly. For example, another way of improving planting performance relates to the physical dynamics of simply placing seeds in a furrow at mechanized speeds.

Planting machines have many moving parts that repetitively take potato seeds at rest from a seed bin and then drop them in a row in the ground. While the planter can drop seeds at precisely timed moments that are intended to create precise spacing from one seed to the next in the ground, the reality is that seeds hit the ground with a certain velocity and momentum, coupled with irregular seed shapes. These factors contribute to seed roll.

Differences in the amount of roll, caused by differences in seed shape (e.g., rounded vs. cut surfaces) cause some seeds to be too close together and others to be too far apart. The end result is plant crowding that causes deformities and, as a consequence, price decreases for the farmer. Therefore, whether it be “skips,” too much rolling, or other kinds of things, any improvements in precision relating to seed spacing while planting potato fields is likely to improve productivity for the farmer.

The designs and improvements disclosed here are intended to address problems of the above kind.

### SUMMARY OF THE INVENTION

The invention or inventions described here provide improvements to the operation of cup-style potato seed planters, in particular. Conventional planters of this type have an upright, endless (or continuous) conveyor with two rows of off-set cups. These cups pick up seeds from a seed bin during upward travel of the conveyor belt and then drop the seeds in the ground, spaced-apart in a row, at the end of the belt's downward leg of travel.

The design disclosed here modifies the belt and cup arrangement or configuration on the typical machine. In the design disclosed here, the belt is modified by widening it and adding another two rows of cups, one on each side of the two rows in the center. The two rows in the center serve or function as the primary seed conveyor in the same way as conventional machines. That is, they normally pick up seeds and then drop them in the ground. The extra row of cups, one on each side of the primary cups, function to effectively create a secondary conveyor. In essence, the secondary conveyor delivers replacement seeds into the primary conveyor seed cups when they fail to either pick up seeds from the seed bin, or lose them after picking them up, due to machine vibration or similar factors.

The extra cups, which are at times referred to as “seed holders” or “secondary cups” here, pick up seeds in the same way as the primary cups and travel adjacent and parallel to the primary cups, along the same endless conveyor belt path. As described below, they have a different physical shape for the purpose of facilitating the transfer of replacement seeds.

The design disclosed here enables transfer of replacement seeds by gravity—by placing secondary cups slightly offset and very near to their neighboring primary cups. The offset puts the secondary cups above the primary ones during the downward leg of conveyor belt travel, so that replacement seeds transfer by the force of gravity. However, it is foreseeable that there could be other ways of accomplishing effective replacement seed transfer from secondary to primary cups such as, for example, jets of high pressure air or some type of mechanical actuator. If so, it may not be necessary to use gravity, and it may not be necessary to physically offset secondary cups up or down on the belt relative to the primary ones, so long as the secondary cups are near enough to move replacement seeds from secondary to primary cups.

As indicated above, the path of conveyor travel includes a downward component that is directed toward the ground. During the downward stage, every primary cup will have a secondary cup on the outside that is a counterpart cup for providing a replacement seed, if a replacement seed is needed. Replacement seeds are fed to primary cups via a gating mechanism.

A sensor system detects when each primary cup is empty. Unless corrected, this will create a skip in the planting row. The sensor provides an informational signal that identifies the empty primary cup and its location on the conveyor belt. While there are different ways to generate a signal of this type, in essence, it can be as simple as a digital “one” or “zero” created by an optical sensor that looks at seed cups as they move along with the conveyor.

In the improved system described here, the optical sensor “looks” through the conveyor belt at seed cups on the other side. The belt has a small opening adjacent to each primary seed cup, at least, that passes across the line of sensor view as the belt moves. This allows the sensor to trigger a signal that indicates the cup is full or empty, as the case may be.

A gating mechanism, on the side of the planter opposite from the seed bin, enables seeds to be selectively fed from secondary to primary cups during the conveyor's downward path of travel, if an empty primary cup is detected by the sensor system. The gating mechanism is an endless chain of individually controlled gates, each one of which normally provides a barrier between primary and secondary cups. In those instances when an empty primary cup is detected on the belt (which will be a relatively small percentage), the appropriate gate is opened, thus allowing a replacement seed to pass to the primary cup from its adjacent secondary cup.

It is believed that the most efficient implementation of the above design is to place the primary and secondary conveyors on the same conveyor belt, so that all primary and secondary cups are traveling in parallel, and at the same speed, all of the time. It may be possible, however, to create primary and secondary conveyors that are mechanically different but have the same functionality. For example, it may be mechanically feasible to put primary and secondary cups on separate belts that are independently controlled, but at least share a segment or component of parallel travel so that replacements seeds can be transferred from one cup to another. Time may prove that alternatives like these are better for some reason. In all cases, however, the concept is to provide a secondary conveyor as a source of replacement seeds when an empty seed cup is detected on a planter's primary seed conveyor.

There will be instances when secondary cups are also empty after passing through the seed bin for the same reasons that primary cups are empty. However, the probability is low that both a primary and adjacent secondary cup will leave the seed bin empty. As a consequence, the replacement method described here should reduce or avoid the possibility of a planting skip. Moreover, it represents a relatively simple and low cost design modification to existing cup-style planters.

The sensing function disclosed here—that is, sensing empty cups in a cup-type conveyor, could be used on conventional conveyors even if no seed replacement mechanism is provided. Simply knowing the rate of skips on an ongoing basis is valuable information to the farmer because accumulated data may reveal that things like speed and terrain factors influence the rate of skips. In such case, it may be possible to make field adjustments that provide immediate improvements. As indicated above, even minor improvements in skips can represent significant increases in revenue.

Yet another improvement disclosed here relates to planting speed. Regardless of the particular machine design (i.e., “pick,” “vacuum,” or “cup”), potato planting machines usually work the same way from the standpoint that potato seeds are dropped by gravity into the ground. There is a good deal of dynamic motion during the planting process because of a combination of factors. These factors include relatively high speed of rotation of a wheel (with spikes or vacuum tubes), or a quickly moving conveyor belt (with seed cups), as the machine traverses along a furrow line. This, along with the planter's forward movement along the furrow line, creates a tendency for momentum to cause the seeds to roll when they hit the earth inside the furrow. Too much rolling is undesirable because it creates randomly uneven seed spacing in the furrow—which, as indicated above, is a problem that is independent from planting skips.

The rate of wheel or conveyor belt rotation is timed or synchronized according to the rate of machine travel across the ground. The tractor that pulls the machine will typically have a ground speed of several miles per hour. If the tractor is put into a higher gear, which means it will pull the machine at a faster ground speed, the rate of rotation of wheel or conveyor components likewise increase proportionately, so that seeds are dropped at the desired preset distances in the furrow. At some point, however, there is a limit to tractor speed because further speed increases cause the planting machine to impart increased dynamic momentum to the seeds when they hit the ground, such that uncontrolled rolling becomes unacceptable.

Disclosed below is another improvement for a potato seed planter that should allow increases in tractor speed—to the extent that tractor ground speed is currently limited by seed rolling. Once again, while this improvement is described here in the context of a “cup” style planter, and it may be the only type of design where it can be implemented effectively, the concept that creates the improvement is not necessarily limited to the specific mechanical structure that accomplishes it. It is an issue of relative speed. That is, the concept disclosed here involves changing the momentum and net horizontal speed vector of a potato seed relative to the ground when it is dropped or exits from the planting machine.

Modifying a cup-style planter to utilize this improvement involves altering the conventional path of conveyor belt travel. The conveyor (or conveyor belt) travels upward through the seed bin on one side of the planter in the usual way. As a frame of reference, this side is “aft,” and the tractor driver will not see it, should the tractor driver look backward. The conveyor then passes over a roller, or similar mechanism, at the top, and begins a downward path of travel on the other side, or forward-looking side. What is different about the design disclosed here is this: at the end of the belt's downward travel, it reaches a lower portion where it travels backward in a direction that generally follows the ground. This direction may be close to horizontal, or at a slight upward incline relative to horizontal, so long as the path of belt travel is changed sufficiently to reduce seed speed and momentum relative to the ground as seeds exit the planter.

The belt on modern cup-style planters follows an oval track that is defined by a roller at the top and another one of equal size at the bottom. In accordance with the improvement described here, a second, lower roller is added that causes the belt to travel a path that deviates from oval toward slightly triangular. The lower leg or side of the triangle is close to parallel to the ground and the upstanding conveyor is close to perpendicular to the ground. It might be possible to accomplish the same dynamic change in momentum by using a single, large roller at the lower end of the belt. Either way, the concept is to slow down the velocity of potato seeds relative to the ground before or as they exit the machine—which means that their momentum will be reduced when they hit the furrow.

The above improvement allows tractor speed to be theoretically increased to some higher limit before seed rolling in the furrow again becomes a problem. While this may seem like a subtle change, the productivity improvements can be significant. If tractor ground speed can be increased from 4 to 5 mph, for example, with no resultant loss in seed spacing accuracy, then it can mean significant time savings that will be measured in planting days for commercial potato growers who plant large acreages—and for a very low-cost design change.

### BRIEF DESCRIPTION OF DRAWINGS

In the drawings, like reference numerals and letters refer to like parts throughout the various views unless indicated otherwise, and wherein:

FIG. 1 is a perspective view of one “row” of an improved cup-style potato seed planter constructed in accordance with the invention, looking at what would be the forward side of the planter relative to the direction of machine travel;

FIG. 2 is a side view of the planter shown in FIG. 1;

FIG. 3 is a perspective view similar to FIG. 1 but shows the planter with the shell of an exterior housing removed, to expose an endless conveyor that is used to plant potato seeds, and to also illustrate cup guides, or channels, that separate cup rows on the conveyor;

FIG. 4 is a side view of the FIG. 3 illustration;

FIG. 5 is a perspective view that shows a top portion of the endless conveyor;

FIG. 6 is a perspective view of the planter, similar to FIG. 1, but with furrow-covering structure broken away, looking at the side of the planter that faces the rear of the machine relative to the direction of machine travel;

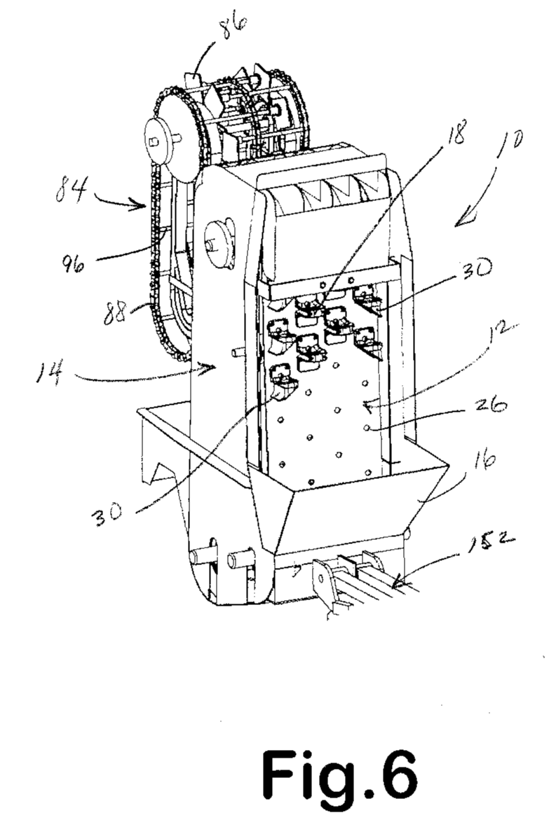

FIG. 7 is a rearward, perspective view of the conveyor;

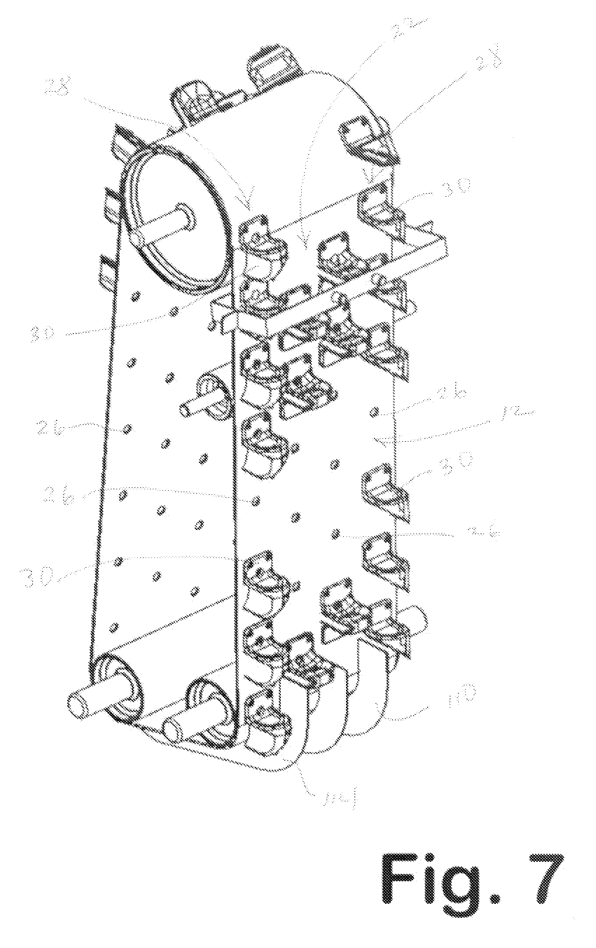

FIG. 8 is an enlarged sectional view of a portion of the conveyor shown in FIG. 7 and other Figs., looking at the rearward side of the conveyor;

FIG. 9 is a view that is similar to FIG. 8, but shows an enlarged sectional view of the conveyor on the forward side or, in other words, the side of the planter that faces the forward direction of planter travel;

FIG. 10 is a side view of a cam rail that causes individual gates to open for allowing replacement seeds to be transferred to primary seed-planting cups on the conveyor;

FIG. 11 is similar to FIG. 10, but also shows a chain drive for the gates that collectively create a gating mechanism for the seed planter;

FIG. 12 is a perspective view of the gating mechanism;

FIG. 13 is an enlarged perspective view of the upper, forward side of the planter housing, with the gating mechanism removed;

FIG. 14 is a perspective view similar to FIG. 13, but looking from a direction that is above and down toward the aft side of the housing, and shows both the gating and seed conveyor mechanisms removed, to reveal housing channel structure that separates rows of cups on the conveyor; and

FIG. 15 is a bottom view of the planter and planter housing, showing where potato seeds exit the planter.

### BEST MODE FOR CARRYING OUT THE INVENTION

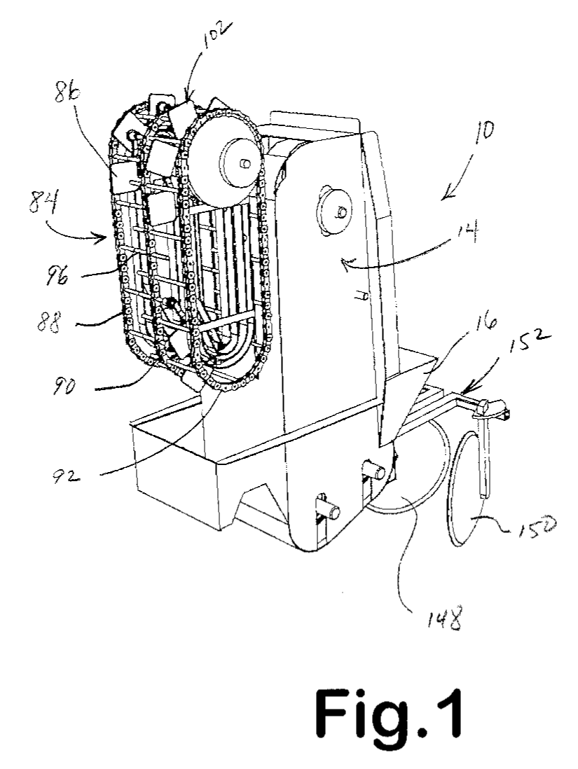

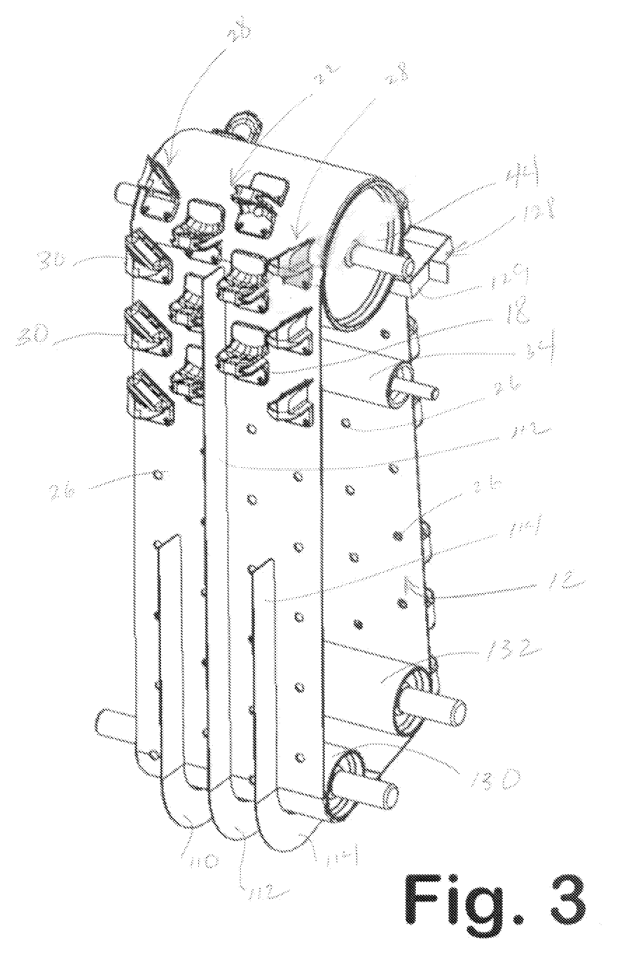

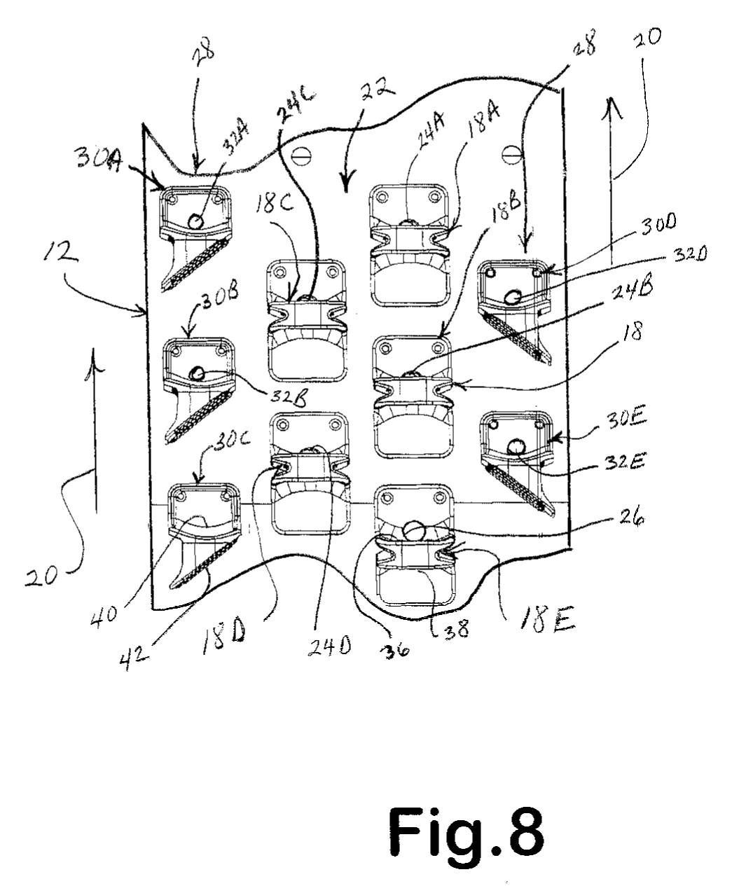

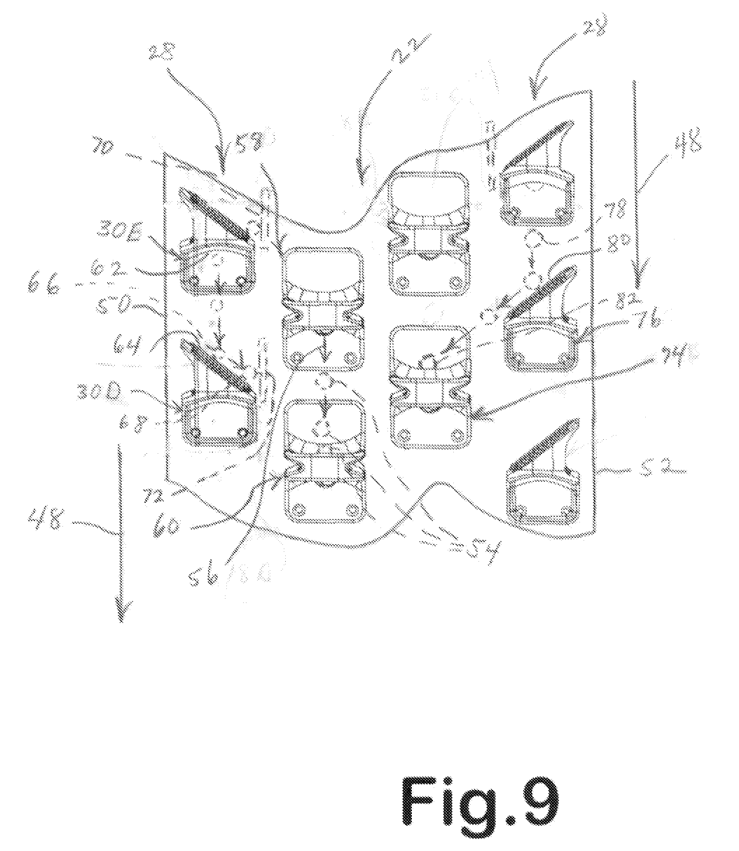

Referring now to the drawings, and first to FIG. 1, shown generally at 10 is an improved potato planter constructed in accordance with the invention. The planter 10 is a “cup” or “cup-type” planter. It has a conveyor belt 12 (see, e.g., FIG. 3) that is inside a housing structure 14. A seed bin 16 holds seed potatoes for planting in the field. The conveyor belt 12 is covered with seed holders, or seed cups 18, 30 (FIG. 3), rows of which are also generally indicated by arrows 22, 28 in FIGS. 8 and 9. These cups are bolted to the belt in the same way as existing cup planters.

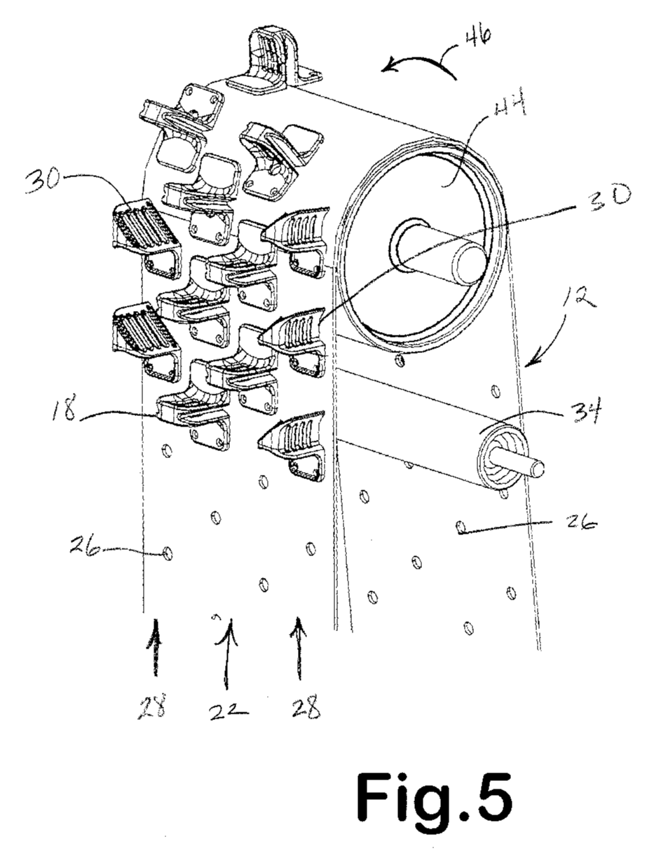

It needs to be explained that the drawings that illustrate the conveyor belt 12 do not show all of the cups 18, 30 on the belt. Referring to FIG. 5, for example, which illustrates the upper portion of the belt 12, it can be seen that the illustration shows only the upper part of the belt as being covered with cups. In actual practice, the entire outer surface of the belt 12 will be covered (with cups), to create four endless rows of cups around the entire outer surface of the belt.

A person familiar with planters of this kind would know that conventional planters have a narrower belt that carries only two rows of cups around the outside. The design disclosed here widens the belt and adds two cup rows, making a total of four rows per belt—rather than the two rows per belt now in use.

Similar to conventional cup-type machines, the belt 12 picks up seed potatoes in the bin 16 as it travels upward through the bin. FIG. 8 schematically illustrates how seed potatoes will rest in the cups at this point. Arrows 20 generally indicate the belt's upward path of travel. As indicated previously, the face of the belt, as shown in FIG. 8, would face aft or away from the direction of machine travel.

Continuing with FIG. 8, and as was summarized above, the belt 12 has two rows of internal cups 18A-E that serve as a primary seed conveyor, also indicated generally at 22. While their outlines do not necessarily reflect actual size, potato seeds 24A-D can be seen resting in these cups, with one cup (18E) being empty and showing an opening 26 through the cup and the belt 12. The purpose of the opening 26 is to provide a skip-sensing function, so that a sensor can “look” through the belt 12, as will be described later.

The belt 12 also has two external rows of cups, indicated generally at 28, that serve as a secondary seed conveyor. The secondary cups are individually identified by arrows 30A-E in the FIG. 8. Four of them, 30A-B and 30D-E, show potato seeds 32A-B and 32D-E in them. The fifth secondary cup, 30C is shown empty.

It is likely that both the primary and secondary cups will occasionally fail to pick up potato seeds from the bin, although the chances are slight that both a primary and nearby secondary cup will be empty after leaving the seed bin. As the belt 12 moves upwardly through the bin 16, most of the cups on the belt 12 will be filled, as illustrated in FIG. 8. For various reasons, some cups will not pick up a potato from the bin 16 or it will fall from the cup during the belt's upward travel.

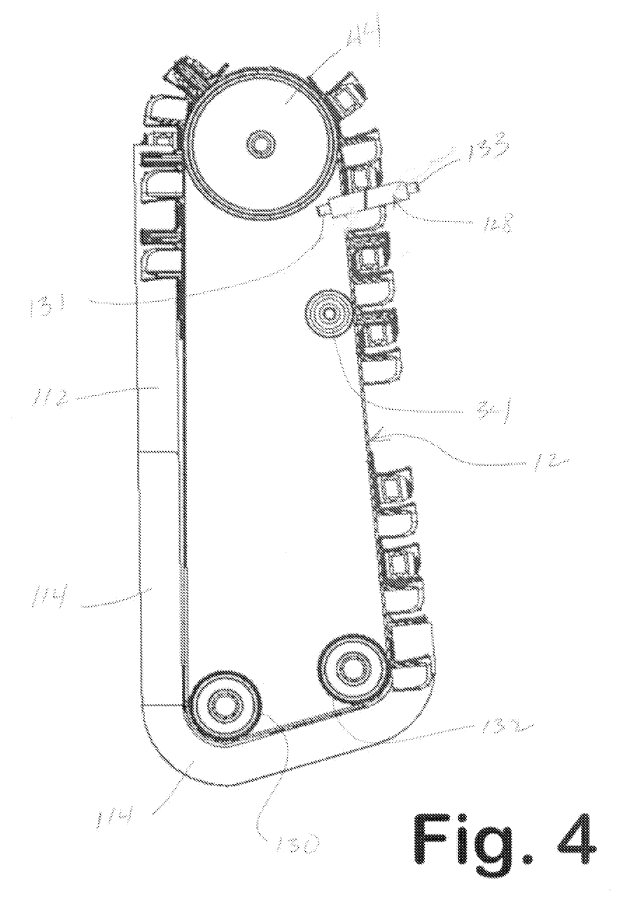

As is common to existing machines, the belt has a vibrating roller 34 or vibrator (see FIG. 4) that shakes the belt slightly for the purpose of shaking off extra potato seeds when individual cups happen to pick up more than one seed. This is not germane to the invention, and does not need to be described in greater detail because it is a known feature of cup-type planters. It is also something that may cause skips.

As illustrated in the drawings, the top and bottom sides of the primary cups 18A-E are essentially mirror images of each other (see arrows 36, 38 on cup 18E in FIG. 8, for example). The secondary cups 30A-E have a different construction.

The top side 40 of each secondary cup is more or less shaped as a cup (see secondary cup 30C in FIG. 8). The bottom side 42, however, is shaped more like a ramp that is sloped down and toward the primary conveyor 22, when the belt 12 is traveling along its downward leg. In other words, what is “top” when the conveyor belt 12 moves upwardly (FIG. 8) is reversed and becomes “bottom” when the conveyor belt subsequently moves down (FIG. 9).

Similar to conventional planters, the belt 12 travels over a roller 44 at the top and begins a downward path of travel on the forward side of the machine (see arrow 46 in FIG. 5). FIG. 9, which is similar to FIG. 8, shows what the belt 12 looks like on the downward side. In FIG. 9, arrows 48 indicate the direction of belt travel. Arrows 50, 52 indicate opposite side edges of the belt. And, as would be expected, the orientation of the various primary and secondary cups 22, 28 becomes reversed on the forward side of the machine, so that the secondary cups are offset slightly above the primary ones (or “vertically offset”), for the purpose of allowing gravity transfer of replacement seeds between them.

When the cups in the primary rows 22 begin their downward path of travel, the seeds picked up in each primary cup drop to the cup below, as schematically illustrated by dashed lines 54 and 56. Line 54 indicates a potato seed while line 56 illustrates how it drops from the cup above 58 to the cup below 60. The seeds are drawn as small balls in the drawings for the sake of illustrating how they move. In reality, an average seed will cover about 75% of the width of the conveyor cup.

The same type of seed transition occurs in the row of secondary cups 28. There, however, potato seeds drop from each cup 62 and fall onto the ramp 64 of the cup below. This is schematically illustrated by dashed lines 66 and 68. The seeds that fall onto the ramp are prevented by gates 70,72 from rolling into the nearest primary cup. These gates are schematically illustrated by dashed lines in FIG. 9.

If an empty primary cup is detected (primary cup 74 in FIG. 9 is shown empty, for example), then the adjacent gate is opened. This removes the barrier between secondary and primary cups and permits the seed 78, resting on the secondary cup's ramp 80, to be fed by gravity into the empty primary cup, as shown at 82. In this way, the secondary conveyor can provide replacement seeds to the cups that make up the primary conveyor on an ongoing basis before the seeds are to be dropped from the machine 10.

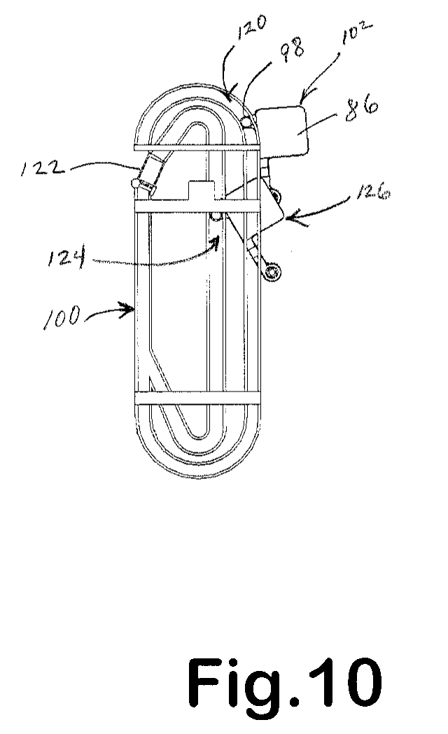

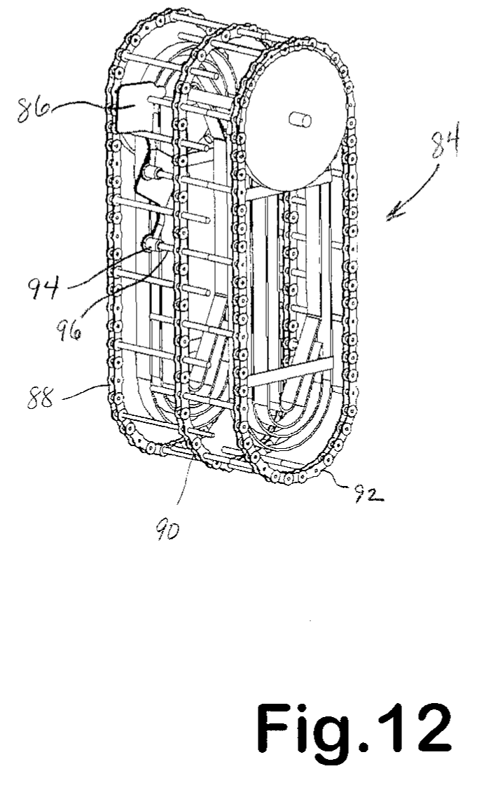

Referring now to FIGS. 1-4, 10 and 12, gating is accomplished by a gating mechanism 84 that is mounted to the forward side of the machine, as shown in FIGS. 1-4. The gating mechanism 84 is essentially an endless chain of individual gates 86 that are individually attached to parallel drive chains 88, 90, 92 by a pivot point 94 (See FIG. 12). Each pivot point is connected to its own dedicated mounting shaft 96 that interconnects the three drive chains, one shaft for each gate that is carried by the gating mechanism. Each gate has a cam roller 98, that runs along a guide track 100 (see FIG. 10) that will be further described later.

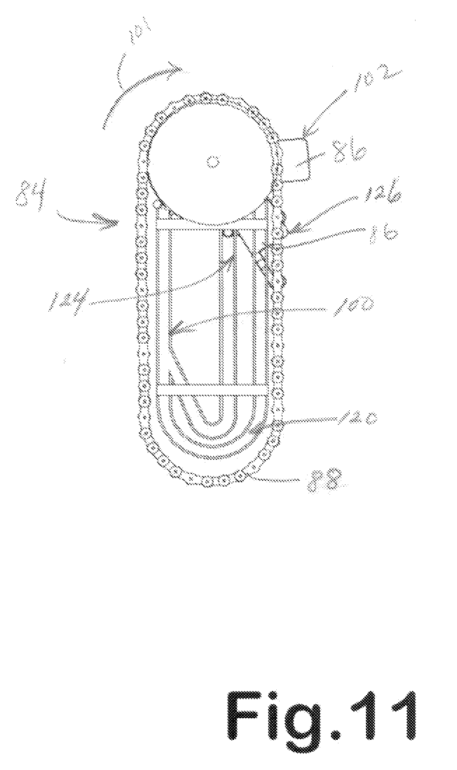

As with the conveyor belt 12 previously described, not all of the gates on the chain are illustrated here, because it complicates the illustrations and the reader's ability to understand this description. It is to be understood that two endless rows of gates are positioned around the entire length of the endless loop defined by the chains 88, 90, 92 in the gating mechanism 84. The gating mechanism 84 continuously rotates in the direction indicated by arrow 101 in FIG. 11. This direction is opposite to the conveyor belt's direction of rotation, described earlier and illustrated at 46 in FIG. 5.

The individual gates are normally in the position shown at 102 in FIGS. 1-4 and other Figures. This position is the “closed” position, because it causes the gates 86 to separate primary cups from secondary cups in the manner described above.

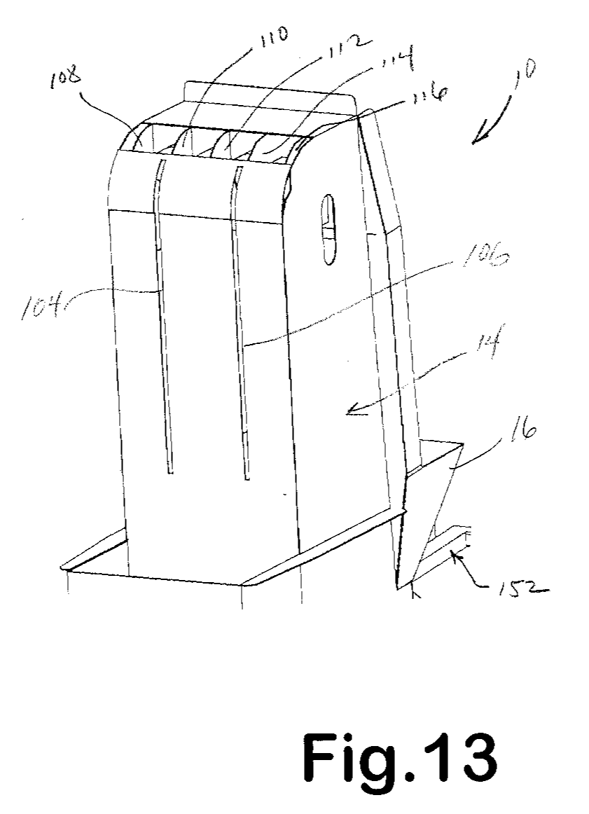

The gating mechanism 84 is driven in timed rotation relative to the conveyor belt 12 such that gates will normally pass through slots 104, 106 (See FIG. 13) in the machine housing 14, on a continuous basis, as both the conveyor belt 12 and gating mechanism 84 rotate. The gates then travel near the forward side of the belt 12 (as previously described and schematically illustrated at 70, 72 in FIG. 9), thus separating the primary conveyor from the secondary one, until the cups pass down below the gating mechanism 84.

The machine housing 14 has guide walls 108, 110, 112, 114, and 116 (See FIG. 13) that separate the rows of cups on the conveyor belt 12 and essentially puts each row in a separate channel. However, a portion of the guide walls is removed at the location where gates 86 extend through the housing 14, to allow the gates to effectively create a moving wall that is segmented according to each respective gate.

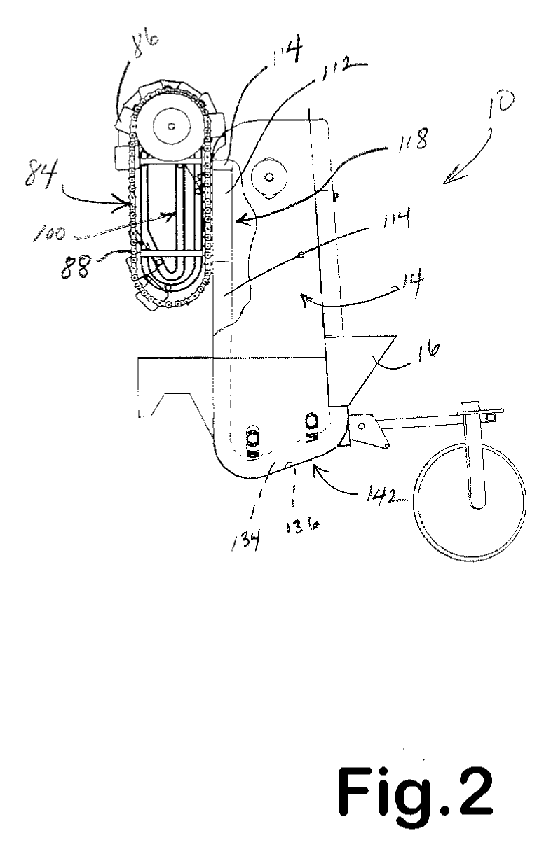

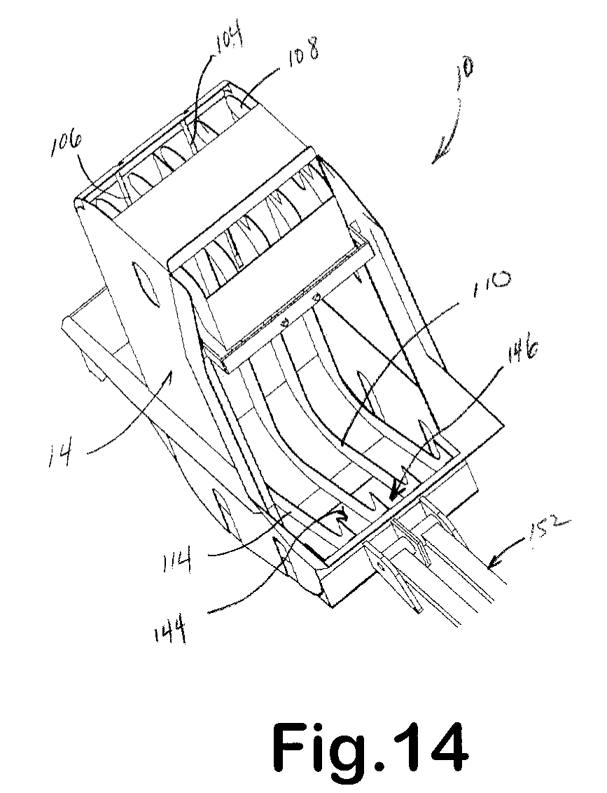

The area where the guide walls are removed is generally indicated at 118 in FIG. 2. The interior guide walls are also seen in FIG. 14, which provides a view of the inside of the housing, but with the interior conveyor belt structure removed. Still another view of the interior guide walls can be seen at 110, 112, 114 in FIG. 3, which shows the shell of the housing removed and locates the guide walls relative to the cups on the belt 12.

Referring to FIG. 10, each gate 86 is linked only to the chains 88, 90, 92 of the gating mechanism 84 and not to each other. As described above, each gate is connected by a pivot point 94 to a mounting shaft 96 that is carried by the chains (FIG. 12). Each gate has a cam bearing 98 that rides along guide track structure 100. The cam bearing normally follows an outer guide track 120 when the gate is to remain in the “closed” position, indicated at 102 in FIG. 10. As previously, indicated, gates will be “closed” most of the time because the vast majority of primary cups on the belt 12 will successfully pick up seeds from the seed bin.

However, when it is desired to open an individual gate, because a skip is detected, then an actuator diverts a portion of the track 122 to redirect the “cam” or “follower” roller 98 into an inner track 124, much like railroad tracks are switched for trains. This, in turn, rotates the attached gate to the “open” position, as shown at 126 in FIG. 10. The opening movement consequently allows seeds to be gravity fed from the secondary cup row to the primary one in the way previously described.

The actuator is not illustrated in the drawings. An actuator that could perform the function just described is conventional and could be implemented easily by anyone with adequate skills to build machinery like the one illustrated here.

The timing of rotation of the gating mechanism 84 needs to be synchronized to the speed of the conveyor belt 12. A conventional optical sensor can be used to detect empty cups as they exit the seed bin 16 and, therefore, sensing may be done in different ways. However, it is anticipated that a sensor system (i.e., numeral 128 in FIG. 4) would briefly “look” through line-of-sight openings in the belt and cup (i.e., numeral 26 in FIG. 8) to view or detect the presence or absence of a seed potato. It is believed this type of sensing arrangement is different from what has been used on planters in the past.

When the seed is absent, for example, a signal is generated that results in temporary actuation of cam track part 122, at the appropriate time, to open the appropriate gate that would otherwise be positioned between the empty primary cup and the adjacent, offset secondary cup.

The control system just described will be implemented by a microprocessor carried by the machine (not shown in the drawings). The sensor system 128, as illustrated here, has a frame 129 that holds one or more optical transmitters 131, inside the belt 12, and corresponding receivers 133 on the outside (see FIG. 4). As indicated above, the transmitters and receivers are aligned to look through the openings 26 in the belt 12 as it moves along its endless path. If an empty cup passes upwardly, then the opening allows a direct line of sight between transmitter and receiver that creates a triggering signal, identifying an empty-cup condition. That condition will then be corrected by controlling the gating mechanism 84 as per the above description.

While it is only necessary, in the present case, to detect empty cups on the two interior rows that make up the “primary” conveyor described here, it is envisioned that skips in the replacement cups might be detected as well (which is why the Figures show four rows of openings 26 in the belt 12). In this way, the farmer should be able to keep track of the total percentage of empty cups. The sensing system 128 could be used in a conventional cup planter to simply keep track of seed skips if desired.

The belt 12 passes over the roller 44 at the top and two rollers 130, 132 at the bottom (see FIG. 4). The two rollers at the bottom create a path of travel that is much closer to horizontal than vertical inside the housing 14. In preferred form, the path of travel is to the rear and at a slight upward incline. For the purposes of interpreting the claims, this structural configuration could be referred to as “horizontally inclined” or “horizontally upwardly inclined” or the like.

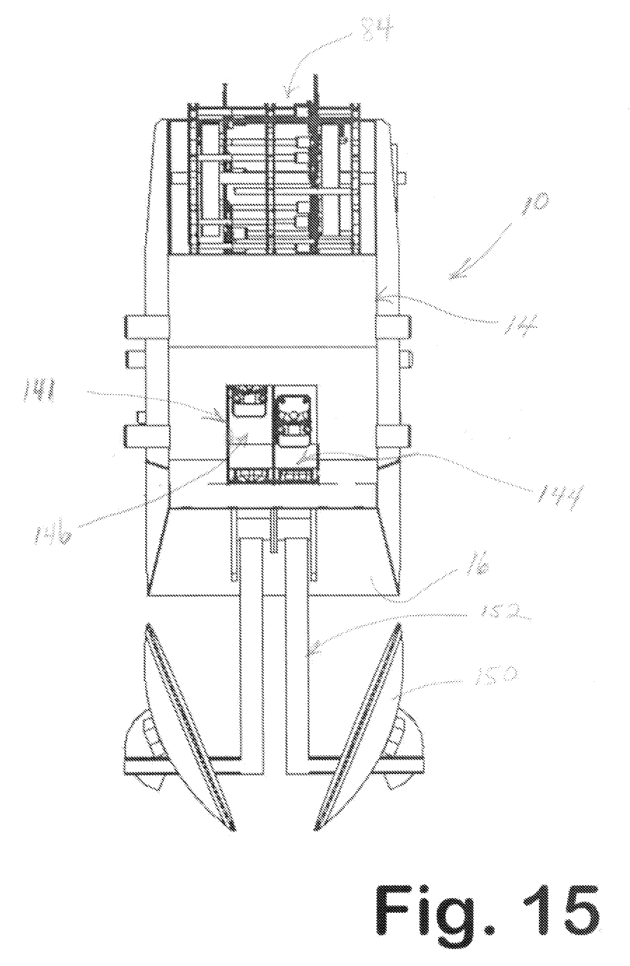

Shields and guidewall structure 134, 136, attached to the housing 14, near the belt 12, cause the cups to push the seeds (see 138, 140 in FIG. 4) back through the bottom of the housing, in the aft direction. An opening 141 in the bottom of the housing (see FIG. 15) allows the seeds to drop down at or about the position indicated at 142 in FIG. 2. Reference numerals 144, 146 in FIG. 14 respectively illustrate one opening for each row of primary cups on the conveyor.

The structure just described alters seed momentum as it exits the planter 10. In the conventional planter, seeds essentially drop vertically from the machine at the lower leg of conveyor belt travel. Turning the seeds back through the housing 14, in the manner just described, imparts a horizontal velocity component that reduces seed momentum and serves to partially offset the speed of the tractor. The net result is that seeds will be slowed down relative to the ground. The slow-down consequently allows the tractor to increase speed.

The secondary or replacement cups, and any unused seeds carried by them, follow the channels on the outside of the housing and return back up through the seed bin 16. As of the date this document is filed, it is believed that it is unnecessary to empty and refill secondary cups as they travel endlessly around the belt 12. However, if seed bruising arises, then it may be necessary to build guide structure that allows the secondary cups to empty before returning through the seed bin 16.

Two discs 148, 150, mounted to the rear of the frame structure 152, cover the furrow in the ground, as the machine is pulled by a tractor. The structure that opens the furrow is not shown here because it is conventional and well-known.

The planter 10, as described here, is one “row module” that would be combined with other identical modules on a much larger wheeled frame—which is a common way of making potato planters today. The wheeled frame is not illustrated here because it is not germane to the improvement described here. Farmers and machinery manufacturers would readily understand how individual modules like the one described and illustrated here would be combined to make multiple row seed planters.

The above description is for illustrative purposes only and is not meant to limit the scope of the invention. It is to be understood that changes and variations may be made to the mechanisms and structures described here, and/or future improvements could be made, that do not depart from the spirit of the invention. In particular, the purpose of the invention is to provide replacement seeds in a planter that minimizes or eliminates the seed skipping problem. It is possible that different kinds of mechanical arrangements could be, or will be, devised that can deposit replacement seeds in the ground when a primary seed conveyor fails to pick up a seed from a bin for any reason. Different kinds of gating mechanisms may be devised, in particular, but ones that nevertheless provide the same functionality. The scope of the patent right, therefore, is to be limited only by the claims that follow, the interpretation of which is to be made in accordance with the standard doctrines of claim interpretation.

What is claimed:

1. A potato seed planter that includes at least the following:
a primary seed conveyor having a plurality of seed cups that pick up potato seeds from a seed bin and drop the seeds into a row in the ground;
a secondary conveyor for replacing seeds when a seed cup on the primary conveyor is empty, the secondary conveyor being adjacent and parallel to the primary conveyor during at least a segment of common travel, the primary and secondary conveyors being capable of traveling an endless path that includes a downward direction toward the ground, and further, the secondary conveyor being positioned relative to the primary conveyor in a manner so that, when both conveyors are moving downward, individual seed holders on the secondary conveyor are near a counterpart seed cup on the primary conveyor and positioned to allow a replacement seed to be fed into the counterpart cup;
a sensor system for detecting an empty-cup condition on the primary conveyor; and
a gating mechanism for selectively enabling timely feed of a replacement seed from a replacement seed holder on the secondary conveyor into a counterpart cup on the primary conveyor, when the sensor detects an empty-cup condition for the counterpart cup, for the purpose of avoiding a skip in seed planting.

2. The planter of claim 1, wherein the replacement seed is fed into the counterpart cup by gravity.

3. The planter of claim 1, wherein the sensor system includes a plurality of openings, at least through the primary conveyor, one opening adjacent each location where a seed is normally held by a seed cup, and a sensing device that is operative to view the location where each seed is normally held by sighting through the openings as the conveyor moves, to detect the presence or absence of seeds.

4. The planter of claim 1, wherein the primary conveyor comprises at least one row of seed cups on a conveyor belt, and the secondary conveyor comprises at least one row of seed holders, adjacent to the row of seed cups, on the same conveyor belt.

5. A method for reducing or eliminating planting skips in a cup-type potato seed planter, comprising:
providing a secondary conveyor as a source of replacement seeds when an empty seed cup is detected on a planter's seed conveyor, the secondary conveyor having a plurality of seed holders for retaining replacement seeds;
positioning the secondary conveyor near the seed conveyor to enable a replacement seed to be selectively fed from a seed holder on the secondary conveyor to an empty seed cup on the seed conveyor, to thereby avoid a planting skip.

6. The method of claim 5, wherein the replacement seed is selectively fed to the detected empty cup by gravity.

7. A sensor system for detecting an empty seed cup in a cup-type potato seed planter having a moving conveyor belt and seed cups on the conveyor belt, comprising:
a plurality of openings that provide an open window through the belt to the location on each cup where a potato seed is normally held; and a
sensing device operative to briefly view through each opening to the cup location where the seed is normally held as the belt travels, and to generate a signal each time an empty cup is detected at such location.

8. A method for improving seed spacing in a cup-type potato seed planter, comprising:
providing an upright, continuous belt, seed conveyor that picks up potato seeds while traveling upward on one side and then carries the seeds downward on an opposite side to a lower conveyor portion, the lower conveyor portion traveling in a direction that is generally opposite to ground movement of the planter; and
releasing the seeds after the lower conveyor portion has redirected the direction of the seed from mostly downward to mostly rearward, to reduce seed momentum and velocity relative to the ground before the seeds exit the planter.

9. The method of claim 8, wherein the endless belt includes an upper roller and a pair of lower rollers, with the lower portion of the belt traveling between the lower rollers in a horizontally inclined direction.
